(19) United States
(12) Patent Application Publication
(10) Pub. No.: US 2024/0375031 A1
(43) Pub. Date: Nov. 14, 2024

(54) Zeolite and interferon coated disposable particulate respirator and air filtration media

(71) Applicant: William L. Robinson, JR., Baltimore, MD (US)

(72) Inventor: William L. Robinson, JR., Baltimore, MD (US)

(21) Appl. No.: 18/445,168

(22) Filed: May 9, 2023

(51) Int. Cl. B01D 39/16; A41D 13/11; A62B 23/02; B01D 37/02; B01D 53/18

(52) U.S. Cl. CPC B01D 39/1623; A41D 13/11; A62B 23/025; B01D 37/025; B01D 53/18; B01D 2252/10; B01D 2257/504

(57) ABSTRACT

A method and use of Zeolite, Polyethylenimine (PEI) and Benzalkonium Chloride Polymer coated air filtration media designed to absorb CH₄ and CO₂ and airborne bacterial and viral biological agents and a method and use of Polyacrylonitrile (PAN), Interferon, Vinegar and Zeolite coated disposable respirator media to absorb airborne deleterious pollutants such as PM_{2.5} and biological agents such as Influenza, SARS and COVID-19 viruses and respiratory bacteria and protect the wearer from inhalation of said pollutant and deleterious agents.

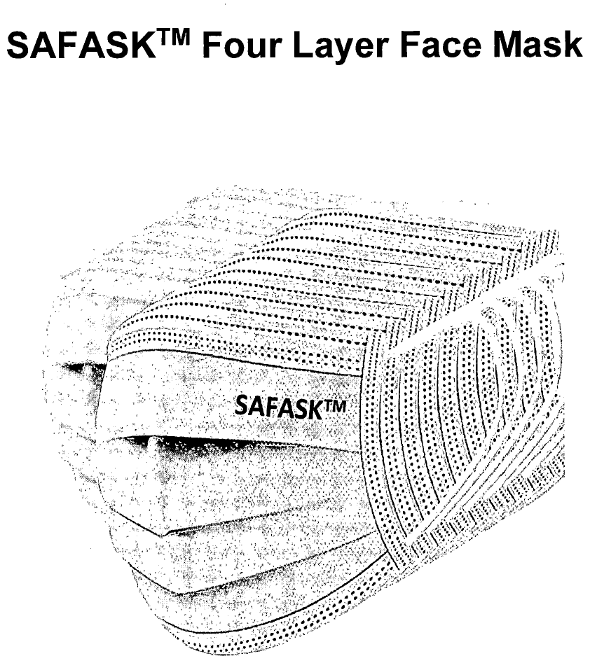

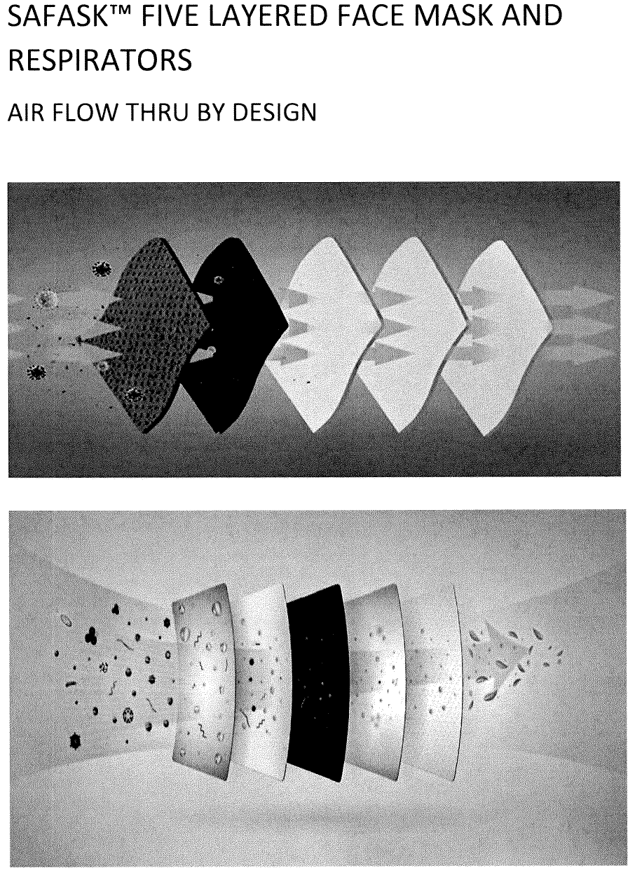

This patent application is a continuation-in-part of U.S. patent application Ser. No. 16/974,311.

### BACKGROUND OF THE INVENTION

### 1. Field of the Invention

The present invention provides Zeolite, Polyethemine (PEI) and Benzalkonium Chloride (BAC) coated mechanical air filtration media and zeolite, vinegar, iodine and interferon coated half faced disposable particulate respirator polypropylene mask media, the latter having the function of assisting containment and removal of biological toxins such as SARS and COVID viruses from the body for health and therapeutic effects.

### 2. Discussion of the Related Art

The emission of exhausts from motorcycles, diesel powered automobiles, coal fired power plants (and in the case of Fukushima, Japan where ongoing radioactive fallout is occurring) have made air pollution an increasingly serious health problem, globally! CO₂, NOx, CH₄, VOCs, PAHs and PM_{2.5} are among the main culprits and are a direct result of global industrialization. The question is how do you deal with interboundary air pollution?

Although, inhalation of fibrous zeolites (large particle size, long, wide fibers not found in Clinoptilolite) have been implicated in pathogenesis of mesothelioma and lung fibrosis, SEM images show that Clinoptilolite (Zeolite) fibers are round in shape and in clinical tests with humans did not produce AM toxicity (pulmonary disease). Micronized Clinoptilolite have been shown to have anticancer and antioxidative Effects when ingested in a biological system.

Soon after SARS-COV was identified as a disease causative agent antiviral screening programs reported several antiviral agents that inhibited SARS-COV replications invitro. These results lead to the experimental use of protease inhibitors and Alpha Interferon (IFN∞) in the treatment of patients. The Interferon response is one of the major innate immunity defenses against virus invasion. Interferon induced the expression of diverse interferon-stimulated genes, which can interfere every step of viral replication. Previous studies have identified type I Interferon as a promising therapeutic candidate for SARS.

Invitro data shows SARS-Co2 is even more sensitive to type I Interferon than SARS CoV, suggesting the potential effectiveness of type I Interferons in early treatment of COVID-19. In China vapor inhalation of Interferon ∞ is included in the COVID-19 treatment guidelines

The present invention provides a disposable particulate respirator filter media having multiple functions of air filtering and when combined with PAN and Interferons and vinegar and zeolites filter materials have bactericidal, bacteriostatic and medication release effect and can be worn for health or therapeutic purpose.

The present invention also provides an air filtering product having multiple functions that can be used to filter air streams containing CH₄, CO₂ and biological substances.

### 3. Statement of Need

There is a need for a way to safely use Zeolites and Interferon to trap air pollutants e.g. NOx, H₂S, VOCs, PAHs, CH₄, PM_{2.5}, CO₂, PAN and biological agents such as bacteria and viruses.

### SUMMARY OF THE INVENTION

The object of the present invention is to provide coated AC air filtration media and, disposable particulate respiratory media the latter when combined with antibacterial agents such as interferons, vinegar and zeolites can achieve bactericidal and/or bacteriostatic effects.

### DETAILED DESCRIPTION OF THE INVENTION

The zeolite coated polypropylene filtration media can be a combined with coated interferon or iodine and vinegar bactericidal and/or bacteriostatic filter material in netted construction, which makes it a disposable filter and can be replaced or repeatedly used.

An embodiment, is the absorbent materials for the filtration device therein is zeolites and interferon having therapeutic effects when the mask is worn.

Another embodiment of the present invention shows that polyacrylonitrate (PAN) can be layered and combined with layers of acetic (vinegar) or citric acid coated air pollution absorbing zeolites ˜60%-80% and a corresponding 40%-20% boehmite (retention aid) binder in de-ionized water (5:1 ratio) at pH 8-9, specifically 8.5-8.-9 at 28-30 C, and an organic polymer containing Hyroxypropylcellulose (HPC)+Ethoxylate Methyl Glucoside (EMG) ˜60%-40% (ratio) (the Curie Formula) to produce air conditioning media.

The preferred embodiments of the present invention have been disclosed in the aforementioned. However, the aforementioned examples should not be construed as a limitation on the actual applicable scope of the invention, and as such, all modifications and alterations without departing from the spirits of the invention and appended claims shall remain within the protected scope and claims of the invention.

What is claimed is:

1. A Method of producing mechanical air filtration media containing absorbent materials such as Clinoptilolite or Chabazite (Zeolite), Polyethyleneimine (PEI) and Benzalkonium Chloride (BAC) as CO2 air pollution absorbing/trapping agents dissolved in de-ionized water coated onto woven or nonwoven (polypropylene) fabric comprising:
a) combining layers of Zeolites, Polyethyleneimine (PEI) and Benzalkonium Chloride polymer coated spunbond/meltblown polypropylene fabric for CO2 collection from an air stream.
b) then adding a layer of the step of mixing radiation and air pollution absorbing materials ˜60-80% zeolite and correspondingly 40-20% boehmite (retention aid) binder in de-ionized water (5:1 ratio) at pH 8-9, specifically 8.5-8.9 at 28-30° C., specifically 28.8° C., and an organic polymer containing Hydroxypropylcellulose (HPC)+Ethoxylated Methyl Glucoside (EMG) ˜60%:40% (ratio) (Curie Formula sealant) (to minimize particle separation from the substrate creating dust), for two (2) 16 minutes,
c) This Hazardous Emission Particulate Analysis (HEPA) tested (0.1-0.3 microns) air filtration media maybe coated with a Mayer rod. The bottom (first three layers) dry aim thicknesses are 1.8 mil and the top (or sealant) layer is 1.4 mil, air penetration is 0.001-0.003.
then,
d) the step of applying (spraying or dipping) or coating the absorbing material onto a woven or nonwoven (spunbond/meltblown polypropylene) fabric,

2. A method of producing disposable face masks and particulate respirator filtration media comprising the steps of: a) combining one (1) layer of Polyacrylonitrile (PAN) and one layer of acetic (Vinegar) or citric acid and Curie Formula coated spunbond polypropylene to form the top two (2) layers 1.4 mil thickness (each) with a third layer of spunbond coated with alpha interferon or iodine pH 6.0-6.5 and a fourth layer comprised of zeolite and Curie Formula coated absorbing materials ˜60-80% zeolite and correspondingly 40-20% boehmite (retention aid) binder in de-ionized water (5:1 ratio) at pH 8-9, specifically 8.5-8.9 at 28-30° C., specifically 28.8° C., spunbond material which acts to permanently seal the fabric,
and

3. Alpha, Beta and Gamma Interferon and Zeolite adsorbent materials include but are not limited to zeolite type 13X, zeolite type Y, zeolite type 4A, 5A, ZSM-3, chabazite, clinoptilolite, naptolite, mordenite, Heu, brewsterite, SBN and ZON, mixtures of these can also be used.
